(19) United States
(12) Patent Application Publication
(10) Pub. No.: US 2011/0112913 A1
(43) Pub. Date: May 12, 2011

(54) SYSTEM AND METHOD FOR LIVE MUSIC PERFORMANCE DIGITAL RECORDING, DISTRIBUTION, AND DIGITAL ADVERTISING

(76) Inventor: Ian MURRAY, Culver City, CA (US)

(21) Appl. No.: 12/617,481

(22) Filed: Nov. 12, 2009

(51) Int. Cl. G06Q 30/00; G06F 15/16

(52) U.S. Cl. 705/14.73; 709/231; 705/27.1

(57) ABSTRACT

The disclosure of the present application provides for a live music performance digital recording and distribution system as well as an advertising system that allows a consumer to purchase a digital copy of the live music performance immediately after the conclusion of the live music performance.

### FIELD OF THE INVENTION

The invention generally relates to an apparatus for recording a live music performance and distributing live music performance digital recordings while providing an integrated advertising system, and more particularly to an apparatus for recording a live music performance and distributing digital live music performance recordings to user's preferred MP3 device immediately following the live music performance through a live music performance digital recording and distributing system that provides an integrated digital advertising system.

### BACKGROUND OF THE INVENTION

The music industry has been plagued year-after-year with decreased physical music sales as brick and mortar distributors continue to close doors, as consumers opt to expense digital music hardware and downloads as well as visual entertainment mediums such as video games and DVD's.

The latest reports from Billboard show that US-based album sales plunged 18% in August of 2009 compared to August 2008 and are down 37.2% compared to the same period in 2007. Year-to-date physical album sales are down 14.5% compared to the same point last year, and 31.1% versus 2007.

Although the music industry has shown a decrease in CD's and other forms of music recordings, Pollstar reported North American gross venue box office receipts of $4.2 billion in 2008, up 7.8% from 2007. This increase shows that despite a bleak economy and decrease in CD sales, music fans still insist on enjoying their favorite artists live. The problem faced by the music industry is that after the live music performance, the performance becomes but a memory in the mind of the consumer at the conclusion of the encore followed by a nostalgic escape from the venue. The consumer is often at an emotional high following the show. Further, large shows attract thousands of concert goers that present a potential source of revenue through advertising. The music industry has not, in the Applicant's opinion, provided an adequate system to capitalize on the consumer's enjoyment of the live music performance while generating advertising revenue stemming from such a large number of concert attendees.

U.S. Patent Publication number 2003/0076963 provides for distribution of live music recording files via a radio or cellular tower to the user's cell phone. The files are transferred to two different servers (LVDM and Wireless IP) before reaching the cell phone and will be offered online at a later date. The patent publication does not include a console or tower for direct-to-fan usage or advertising incentive for the venue.

U.S. Pat. No. 7,403,913 provides a system that requires the user to download live music files to their cell phone. Specifically, the user sends an SMS text to the phone number found in the venue in order to order and download music. Cell phone downloads have never been the preferred platform for the digital music consumer base. If a user utilized this or the above patent their live music files would be isolated on their phone which is most likely not their music listening device of choice (computer or MP3 device). The system does not include a console or any advertising incentive to the venue.

U.S. Patent Publication number 2002/0199198 provides a system that allows the user to purchase personalized segments of live show audio, video or still images. The user selects content from a console at the user's seat and the selected segments are sent to the user's cell phone or somehow transferred onto a DVD or CD to take home. Many distributors have tried to burn CD's and DVD's at live shows but none that the Applicant knows of have met the demand in the minimal time that it takes an attendee to exit the venue. The patent mentions an in-seat console but does not incorporate a design for the console

U.S. Patent Publication number 2006/0074679 provides a recording process but does not appear to include the proper steps to ensure a high-quality live recording and editing process that allows the recording to be accessible to a consumer before the consumer is able to leave the venue. The system does not provide for an engineer checking levels during sound check such that the engineer is able to master the live tracks fast enough to transfer to the console in time for consumer download before the consumer has left the venue. Further, the system does not provide an advertising system or any advertising incentive to the venue.

Additionally, the user of this patent would have to purchase a USB pen drive that would accept an MP3 file transfer. With a USB device, the files can not be accessed for listening until you get it to a computer. While the system mentions using an MP3 player as a transfer device, the system does not provide an enablement of a system allowing for an MP3 player to connect to the system. The system incorporating the USB drive requires the user to upload music files to their computer before downloading to a portable music playing device. Further, the device does not include an advertising system to provide incentive present for venues to utilize their valuable space by providing a music sales system.

### SUMMARY OF THE INVENTION

A system has been provided for digitally recording a live music performance and distributing live music performance digital recordings to consumers immediately following the conclusion of a live music performance while providing for a digital advertising system for directing advertisements to attendees of the live music performance. The invention has a live music performance digital recording system for digitally recording and editing a live music performance and a plurality of towers for distributing the live music performance digital recording while providing an advertising system. In a preferred embodiment the towers typically have a computer system for accepting payment from a consumer, an interactive touch screen such that a user can select a live music performance digital recording to purchase and download to an MP3 player, and an LCD display screen configured for displaying streaming images and video that generally is used to display advertisements. The system, in a preferred embodiment, has multiple towers in which one of the towers constitutes a master hub for receiving and distributing the live music performance digital recording and transferred to networked slave units that are also used for distributing the live music performance. In a preferred embodiment, each of the slave units and muster hub unit also has an LCD display screen that is configured to present continuous streaming images and video. In a preferred embodiment, after recording and editing individual tracks of the live music performance, the system transfers the live music tracks recording to a location where the tracks are instantaneously available for download by a consumer through purchasing a digital copy of the live music performance digital recording through the consumer interface on the tower.

In a preferred embodiment of the present invention, the live music performance digital recording system has at least one microphone for transmitting the signal of a live performance to at least one mixing board that is configured to mix the signal of the live music performance. In a preferred embodiment, the signal is generally mixed according to a template mix. The template mix is generated before the commencement of the live music performance that is recorded and subsequently sold to a consumer. The template mix in one embodiment is generated by an engineer during the sound check for the live music performance. In this situation the engineer sets the presets of the mix such that the live music performance is mixed as the signal is generated. After the signal is mixed, it is generally split into at least two signals. These two signals of the mix are subsequently transferred to at least two editing stations. The first of the editing stations begins recording a first part of the mix signal at the start of the first track. When the first track stops recording, the second editing station begins recording. While the second editing station is recording the first editing station edits the start and end of the track. Subsequently when the second editing station is done recording the second track, the first editing station begins recording a third track. Alternatively, the process can start with both editing stations recording the performance simultaneously. While the first editing station is recording the third track, the second editing station edits the second track. In a further embodiment, multiple editing stations continue switching off editing and recording tasks throughout the performance. When each of the editing stations is done editing a track, the editing station transfers the track to the location where the tracks are available for download by a consumer through the tower system.

In another embodiment, the LCD screens of the tower are of greater height than the rest of the tower. In this embodiment, the advertising screen of the towers is accentuated such that a consumer is able to view the advertising system from a distance and/or the consumer is attracted to the advertising system.

In a further embodiment, multiple towers are arranged such that the digital advertising screens present continuous advertising images and video. This allows for a much larger advertising screen thus generating a larger advertisement. In a further embodiment, the system has a rubber resting pad for placing an MP3 player or similar player to allow the consumer to place an article such as a wallet on while the consumer downloads the live music performance digital recording on to the player. Additionally, the system can have multiple interfaces that can each be a separate interface system between the live music performance digital recording and distributing system and an MP3 player. These can include, but are not limited to, firewire connections, USB connections, iPod connections, and any other general connection known to one having ordinary skill in the art.

In another embodiment, the invention is a method of recording and distributing a digital live music performance digital recording. This method includes providing a live music performance digital recording system, providing a live music performance digital recording distribution system, recording a live music performance through the live music performance digital recording system and dispensing the live music performance digital recording through the live music digital distribution system. The live music digital recording distribution system in a preferred embodiment of the method generally has a plurality of towers in which each of the towers has at least one system for accepting payment from a consumer, at least one interactive touch screen configured such that a user can select a live music performance digital recording selection to purchase and download, and at least one interface for connecting a digital music playing device to the live music performance digital distribution system.

Generally, in the method of the present invention, the live music performance digital recording follows the steps of generating a template mix prior to the commencement of the live music performance, mixing a signal of the live music performance generated by a microphone concurrently while the live music performance is occurring, recording the live music performance signal by using at least two recording and editing stations in which the first recording and editing station starts recording the first track of the live music performance. When the first recording and editing station stops recording the first track the second recording and edition station begins recording the second track. While the second recording and editing station is recording the second track the first recording and editing station is editing the first track. When the first recording and editing station is done editing the first track it transfers the first track to a location where the first track is readied with MP3-integrated software and made available for purchase and download by a consumer through the tower. This same step occurs for the second recording and editing station. When the second editing and recording station is done recording the second track, the first recording and editing station begins recording a third track. The second recording and editing station then begins editing the second track. Alternatively, there can be a third or more recording and editing stations that can record subsequent tracks. The stations generally alternate recording and editing until the live music performance is over. After the conclusion of the live music performance, the live music performance digital recording is made available for download through the tower. The live music performance digital recording is dispensed through the tower by a consumer attaching an MP3 player device to at least one of the towers via the interface between the tower and the MP3 playing device, the consumer then selects a live music performance digital recording for purchase and pays for the live music performance digital recording and subsequently downloads the live music performance digital recording.

As noted the term MP3 player device is used to describe devices that play MP3 formatted digital music recordings or any other digital music recording format known to one having an ordinary skill in the art or developed in the future. Additionally, the term live music performance can also refer to a sporting event, a comedy show, a theatrical show, or any other live performance that can be recorded and subsequently distributed. The system can also provide a video recording aspect of the performance that can be distributed to MP3 players that also function as video players. These types of video players can include, but are not limited to, the iPod series of MP3 players that have video screens. In this manner a consumer can not only download and play a recording of a live music performance, but also can download and play a video recording of the live music performance or sporting event.

The present invention opens up two crucial revenue streams for the music industry with direct-to-fan live digital music downloads to an MP3 device of choice while generating new advertising opportunities for venues and their clients. In addition, in another embodiment live music files of the present invention will be available for purchase online within 2 hours of the show's conclusion. Through the present invention, fans will not have to wait until a later date to receive and listen to their purchased music and instead will be able to download and listen to the music before leaving the venue of the performance.

The Ovation Tower is the first stationary interactive live digital music distribution and advertising platform. Generating new revenue streams in venue advertising and studio-quality live digital music downloads; Ovation heightens the concert experience for the fan while introducing the selling power of impulse to a rapidly expanding digital music consumer base.

The purpose of the Summary is to enable the public, and especially the scientists, engineers, and practitioners in the art who are not familiar with patent or legal terms or phraseology, to determine quickly from a cursory inspection, the nature and essence of the technical disclosure of the application. The Summary is neither intended to define the invention of the application, which is measured by the claims, nor is it intended to be limiting as to the scope of the invention in any way.

Still other features and advantages of the claimed invention will become readily apparent to those skilled in this art from the following detailed description describing preferred embodiments of the invention, simply by way of illustration of the best mode contemplated by carrying out my invention. As will be realized, the invention is capable of modification in various obvious respects all without departing from the invention. Accordingly, the drawings and description of the preferred embodiments are to be regarded as illustrative in nature, and not as restrictive in nature.

### BRIEF DESCRIPTION OF THE DRAWINGS

FIG. 1 illustrates a front view of an embodiment of the present invention.

FIG. 2 illustrates a side view of an embodiment of the present invention.

FIG. 3 illustrates an embodiment of the present invention in which multiple tower embodiments are arranged to present a continuous streaming advertising image.

FIG. 4 illustrates a front view of an embodiment of the console for consumer interface with the present invention.

FIG. 5 illustrates an overview of an embodiment of the control of the streaming imagery when multiple towers are arranged to present a continuous streaming advertising image.

FIG. 6 illustrates an embodiment of the flow of the signal from a live music performance as it is mixed concurrently with the live music performance.

FIG. 7 illustrates an embodiment of the flow of travel of the live music performance signal into the editing rigs after it is mixed.

FIG. 8 illustrates an embodiment of the hub file transfer system of the present invention.

FIG. 9 illustrates a screen shot of the initial screen presented to a consumer upon approaching the system of the present invention.

FIG. 10 illustrates the display process of the consumer interactive screen after a consumer has chosen an option from FIG. 9.

FIG. 11 illustrates options for consumer selection after the process of FIG. 10 is complete.

FIG. 12 illustrates a sequence of instructions the screen flashes to a consumer after choosing a selection of FIG. 1.

FIG. 13 illustrates a screen shot of the consumer interactive system after a consumer attaches an MP3 player to the system and begins downloading a live music performance digital recording.

FIG. 14 illustrates the final screen after a consumer has completed a transaction using the system.

### DESCRIPTION OF THE PREFERRED EMBODIMENTS

While the invention is susceptible of various modifications and alternative constructions, certain illustrated embodiments thereof have been shown in the drawings and will be described below in detail. It should be understood, however, that there is no intention to limit the invention to the specific form disclosed, but, on the contrary, the invention is to cover all modifications, alternative constructions, and equivalents falling within the spirit and scope of the invention as defined in the claims.

The invention provides for a live music performance digital recording and distribution system that provides an integrated large scale advertising system. The invention will allow concert goers or attendees of other live performances to purchase a digital copy of a recording of the concert or performance they just attended immediately following the conclusion of the event and subsequently to listen to the digital recording immediately thereafter on their portable MP3 playing device. The system simultaneously provides an avenue to a virtually untouched advertising revenue stream by providing for a streaming digital advertising system that is embodied within the invention.

The current invention will benefit a large number of people and groups associated with the music industry, live music performances, and similar live performances and sporting events. A brief description of some of the general benefits to a sample of the groups benefited by the present invention can be briefly summarized as follows:

Advertisers:

Ovation is an asset to major advertisers, creating a new digital advertising platform designed to impact millions of consumers attending major venue performances worldwide. To accommodate the volume of consumers in attendance, an estimated seventy to one-hundred (70-100) stationary Ovation towers, creating seven to ten (7-10) 20′×4.5° digital video billboards, will be utilized by venues housing major recording artists. Advertisers will have the option to broadcast digital still billboard images and/or full commercials specific to the demographic of consumers in attendance before, during and after performance. On a larger scale, sponsorship of the Ovation platform is an excellent opportunity for a major company to brand themselves an innovator in direct-to-fan digital music distribution (i.e. Pepsi presents Ovation).

Promoters:

Promoters are always looking for new means to reach a greater audience and increase ticket sales. They will benefit from Ovation with an increase in consumer awareness of participating artists with the hopes of improving attendance. Through Internet, TV and print ad campaigns, Ovation will simultaneously boost public awareness of these shows and provide important information for consumers interested in purchasing live music from the Ovation console.

Venues:

Most of the major music venues in the United States are owned and/or operated by large media companies such as AEG. A partnership between Ovation and AEG (or similar) will be formed to optimize Ovation's impact on digital music and advertising sales. This allows sales and marketing departments at each venue to create a new advertising tier to offer major clients greatly increasing ad revenue. Most major venues still rely on print advertising and digital signage. Ovation's digital billboards break the mold, offering a visual spectacle to all in attendance while providing incentive to the venue to occupy their valuable space.

MP3 Hardware Manufacturers:

A majority of consumers that attend performances at major venues already own or have access to an MP3 player. Attendees without the technology will have added incentive to purchase an MP3 player to take advantage of the live music distribution following the performance. An increased interest in digital music downloads and Apple's recent announcement of price reductions on MP3 hardware gives consumers more incentive to invest in products.

Live Music:

Ovation was designed for recording artists with the confidence and musicianship to deliver a quality live performance worthy of consumer download. The artists that continue to lip-sync live will offer recordings similar to their studio album, while artists that deliver onstage will benefit with a new found respect in the musical community aware of the quality of their live performance. With the knowledge that each live show is being recorded and distributed, artists will have to perform with technical precision increasing the quality of live performance.

Consumers:

Prior to Ovation, the live show became a memory at the conclusion of the encore followed by a nostalgic escape from the venue. With the ability to download the concert to an MP3 device via the universal iPod dock, USB or Firewire ports, consumers have the option take the memory home with them, heightening the live show experience. No longer will fans have to settle for a studio album or overpriced t-shirt at the merchandise table. Offering affordable direct-to-fan live digital music in a user-friendly fashion provides a product that won't fade in the wash. A decrease in physical CD sales and what seems like a Renaissance for music downloads proves that consumers are seeking new means for acquiring their favorite tracks digitally.

Record Labels:

Participation by major record labels and their artists is obviously crucial to the success of Ovation. The terms of the record label's share of Ovation digital music revenue is negotiable and will be predetermined in the artist contract or amended to include these royalties. Generating a new revenue stream, a portion of Ovation digital music download monies will be shared by the label and distributed to artists, producers, publishers and the Harry Fox Agency.

Producers:

Record labels generally compensate artist producers prior to recording with the promise of a percentage of backend of physical and digital album sales, and the same goes for Ovation. The industry standard producer's share is 3% of album sales, but remains negotiable.

Performing Artists:

Ovation was designed with the intent to provide a better portion of royalties to performing artists than the current Apple iTunes model. Artists traditionally receive a mere 10% of downloads, with 70% of digital music revenue collected by the record label and Apple retaining 30%. For years, artists have been frustrated with the revenue share of digital downloads and Ovation will provide a better percentage considering this revenue stream would not be realized without their live performance.

Artist Management:

Artist managers' revenue is generally based on a percentage of their artists' income. Managers can expect to see 15-20% of the increased income generated by Ovation digital music sales.

Publishers:

Considering premiere artists performing at major venues, the share of Ovation's digital revenue paid to the publisher (or copyright owner) by the record label is based on the current mechanical rate of 9.1 cents per track (for tracks under 5 minutes in length). The publisher shares this new revenue with their songwriter.

Songwriters:

The songwriter, per their contractual agreement, is paid the mechanical rate for any song recorded and distributed through Ovation. Generally, the songwriter shares ownership of the copyright and therefore any revenue generated by the publisher.

Harry Fox Agency:

Harry Fox Agency is the leading U.S. music rights licensing organization. HFA's Express Live mechanical licensing is designed for the on-site and online concert recording market, providing the required licenses for immediate distribution of the live recordings moments after the show ends, with the flexibility to accommodate the spontaneity of live performance. The agency charges the publisher 4.5% of the license to act as a publisher's agent, issuing mechanical licenses, following up on money, and accounting. HFA will issue Express Live licenses for each of the live Ovation albums recorded and distributed, increasing the company's volume and revenue.

Further, a high percentage of fans that attend these shows are also savvy enough to own and utilize an MP3 player for portable listening. Year-after-year Apple has controlled 60-80% of the MP3 hardware market share. Providing a universal iPod dock, the tower of the present invention allows the user to utilize one of a generally estimated 220 million iPods®, 20 million iPod Touches®, or 100 million iPod Nanos® sold to date by Apple® to upload their live digital music files in the venue. Additionally, the system provides for a Firewire connection and/or similar USB connection that allow users to connect alternative MP3 players to the system and thus expanding the present invention's applicability and usability.

The exemplary embodiments shown in the figures and described below illustrate but do not limit the invention. It should be understood that there is no intention to limit the invention to the specific form disclosed; rather, the invention is to cover all modifications, alternative constructions, and equivalents falling within the spirit and scope of the invention as defined in the claims. For example, while the exemplary embodiments illustrate an MP3 recording system that distributes live music performances onto MP3 players, the invention is not limited to use with MP3 players and may be used with other digital recording and playback formats. While the invention is not limited to use with live music performances, it is expected that various embodiments of the invention will be particularly useful in such devices including, but not limited to, live sporting events, live theatrical performances, and similar events that can be recorded live for immediate purchase following the conclusion of an event. Alternatively, incomplete recordings of a performance can be made available before the conclusion of the performance to fans that leave before the conclusion of the performance. Hence, the foregoing description should not be construed to limit the scope of the invention, which is defined in the following claims.

In the following description and in the figures, like elements are identified with like reference numerals. The use of “e.g.,” “etc,” and “or” indicates non-exclusive alternatives without limitation unless otherwise noted. The use of “including” means “including, but not limited to,” unless otherwise noted.

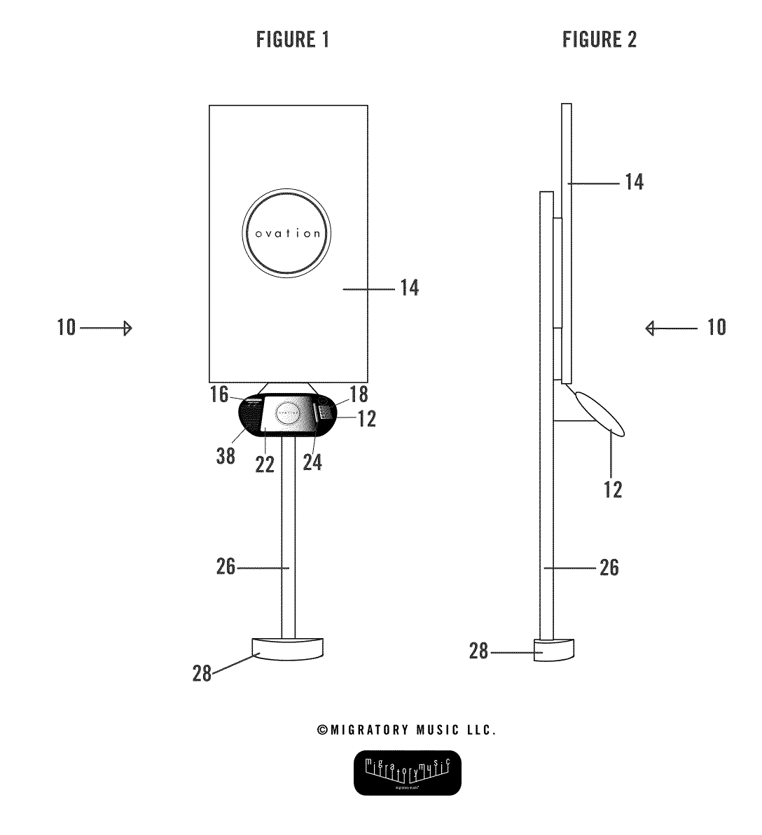

FIG. 1 represents a front view of a preferred embodiment of the Ovation Tower system 10. In a preferred embodiment the system has an LCD advertising screen 14 that sits atop an interactive consumer pad 12. The system is supported by a pole 26 that rests on base 28. As depicted in figure the embodiment of FIG. 1. The LCD advertising screen is 24 inches wide by 42 inches tall. In a preferred embodiment the support pole 26 is 7 inches in diameter while the base supporting the pole is 4 inches in height by 12 inches wide. The overall Ovation Tower in a preferred embodiment stands 7 feet tall. In FIG. 1, the LCD advertising screen in a preferred embodiment is generally taller than the combination of the interactive consumer pad and the pole and base combination in order to focus passersby and consumers on the digital advertising screen. The interactive consumer pad has a digital touch screen 22 that is an interactive consumer interface with the system. Further, the user-friendly interface gives step-by-step instructions to complete the download process downloading the live music performance digital recording to an MP3 player. The software is designed to be visually pleasing and easy enough for younger to more inebriated fan to navigate through. The entire download process of the consumer downloading the live music performance should take no more than a minute from the moment the user approaches the console. In a preferred embodiment, the interactive consumer pad generally has a credit card swipe 24 for payment. Further, embodiment, the interactive consumer pad generally has a back lit keypad 18 to allow consumers to enter in presale ticket codes and debit purchase pin numbers for downloading their purchase. As illustrated, in a preferred embodiment, the interactive consumer pad also has an MP3 rubber resting pad 38 that allows users to rest their MP3 device or other personal items on the console without the device or items slipping off of the console. The interactive consumer pad also has a universal iPod dock 16 in a preferred embodiment and/or an alternative interface for connecting an MP3 player to the interactive console. The interactive consumer pad allows the consumer to download music files through MP3-integrated playlist software directly to an MP3 player. Alternatively, the system can have various other music playing interfaces that will connect a music player such as an MP3 player directly to the Ovation console. These can include USB connections, firewire ports, and any other connection for a music player to connect to the system. Each of these accordingly would have integrated MP3 playlist software in order to allow a consumer to download the MP3 music on to the player.

FIG. 2 illustrates a side view of an embodiment of the present invention. As depicted, in a preferred embodiment of the invention the LCD advertising screen generally stands 24 inches wide by 42 inches tall.

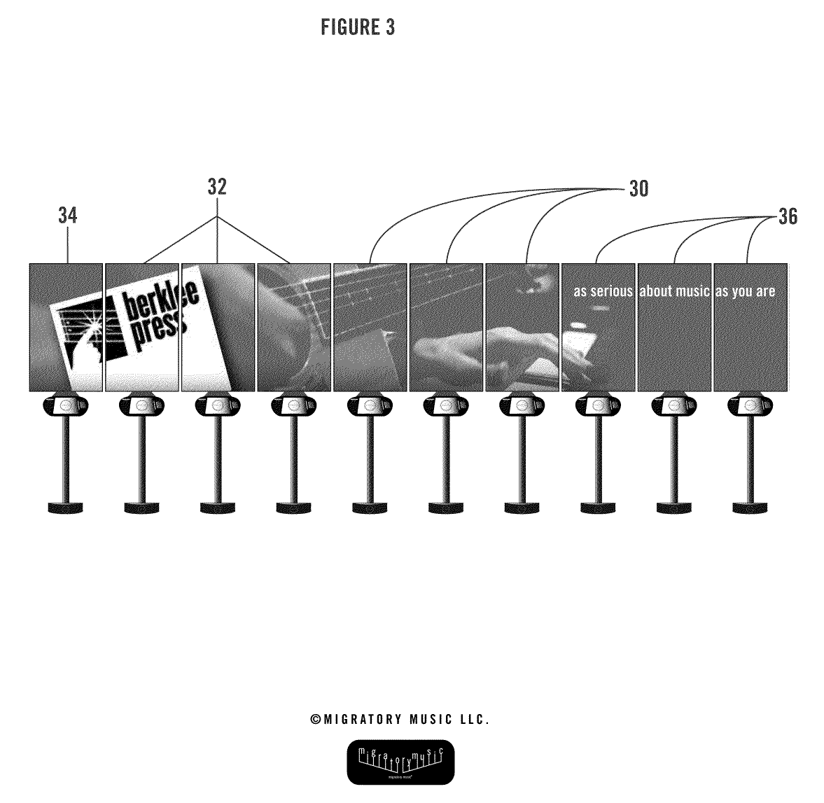

FIG. 3 illustrates an embodiment of the present invention in which ten of the individual towers of the present invention are combined to get a continuous digital advertising screen. While in a preferred embodiment 10 of the towers are aligned, and number of towers can be aligned to suit the venue's needs. The individual LCD screens 34 combined to depict continuous streaming images and video 32. In this embodiment, each of the individual towers in the plurality of screens serves as an individual tower at which a consumer can purchase and download a live music performance digital recording. In the depicted embodiment, the master tower 34 sends the downloadable performance to the each of the networked slave towers 36. Although in FIG. 3 the furthest left tower 34 is the master tower, the invention can be organized such that any of the towers serves as the master tower. Alternatively, there can be more than one master tower controlling a group of slave towers or multiple groups of slave towers controlled by one or more hub towers.

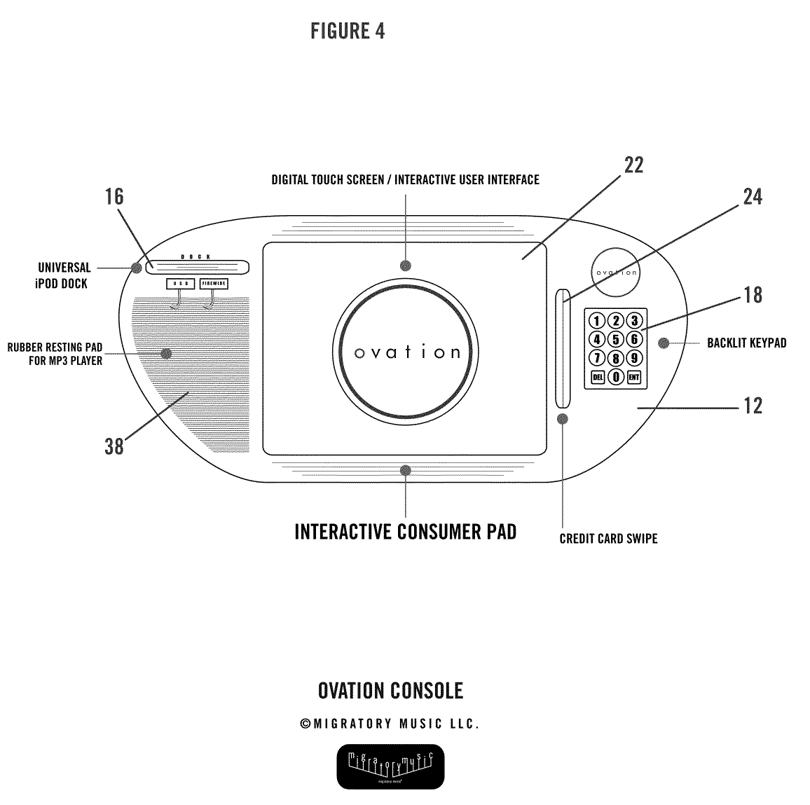

FIG. 4 illustrates the consumer interface console 12 through which the consumer can select, pay for and download a live music performance digital recording. In a preferred embodiment, the consumer pad will have a universal iPod dock 16, rubber resting pad for an MP3 player 38, a credit card swipe 24 for accepting credit cards, a key pad 18 for allowing a user to enter selection numbers as well as debit card pin numbers, and a digital touch screen 22 for the user to interact with the system in order to select, pay for and download a live music performance digital recording. Alternatively, the system can be configured to accept a wide variety of payment including coupons, codes that are entered for discounts or free purchases, or a wide variety of payment options. Alternatively, the system can use biometric scanners that include fingerprint registries, retinal scans, or any similar method of payment that is currently known in the art or developed in the future. Further, the system could be set up such that a user could enter into an online payment system such as PayPal or similar in order to pay for his or her live music performance digital recording.

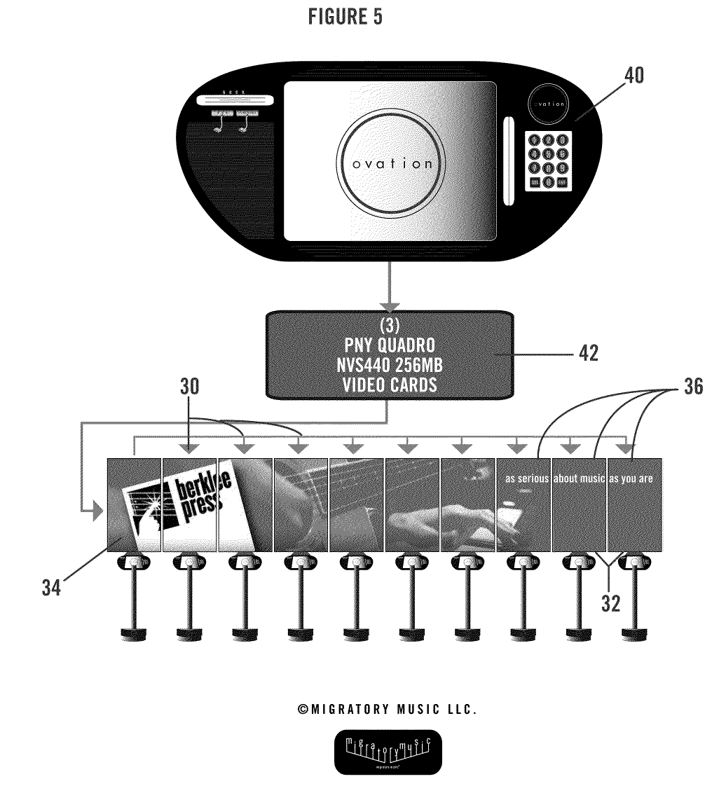

FIG. 5 illustrates the Ovation master hub console 40 operating multiple slave towers 32. In this embodiment the master hub console operated to generate a continuous streaming advertisement 36 through a plurality of aligned towers 30. The master hub console features, in a preferred embodiment, 3 PNY Quadro NVS440 video cards having 256 Megabytes of RAM 42. This system digital advertising platform for the live music performance venue in order to maximize the use of space at the venue while incorporating the live music performance digital recording and distribution system.

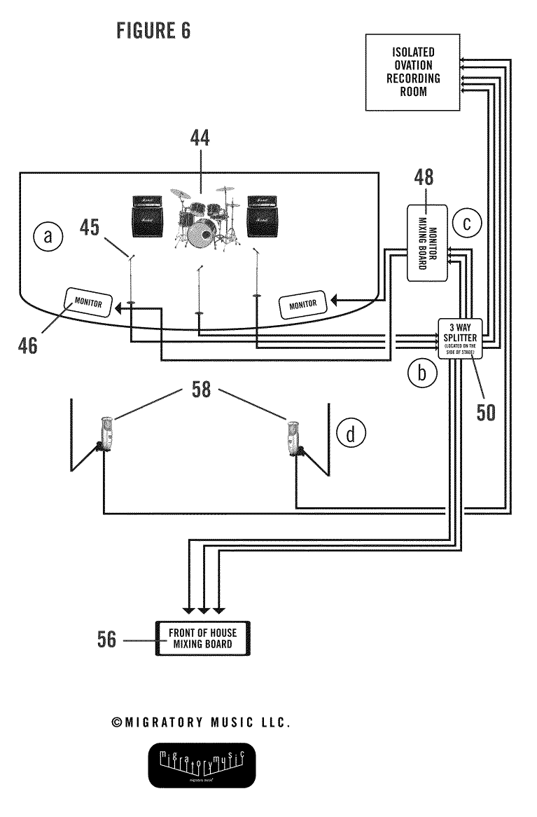

FIG. 6 illustrates the general flow of the signal of a live music performance as it is performed and subsequently mixed a series of on state microphones 45 gather signals of the live music performance. A series of microphone lines transfer the signal. The microphone lines 45 run into a rack of microphone preamps in the Isolated Ovation Recording Room 52. A pair of condenser microphones 58 will be suspended above the middle of the main room to record the crowd and overall stereo image. These microphones will run directly into the Isolated Ovation Recording Room 52. As illustrated, the system includes monitor mixing boards, monitor for on stage adjustment of the sound of the performance, and splitters for slitting the signal of the performance as would be known to one having ordinary skill in the art.

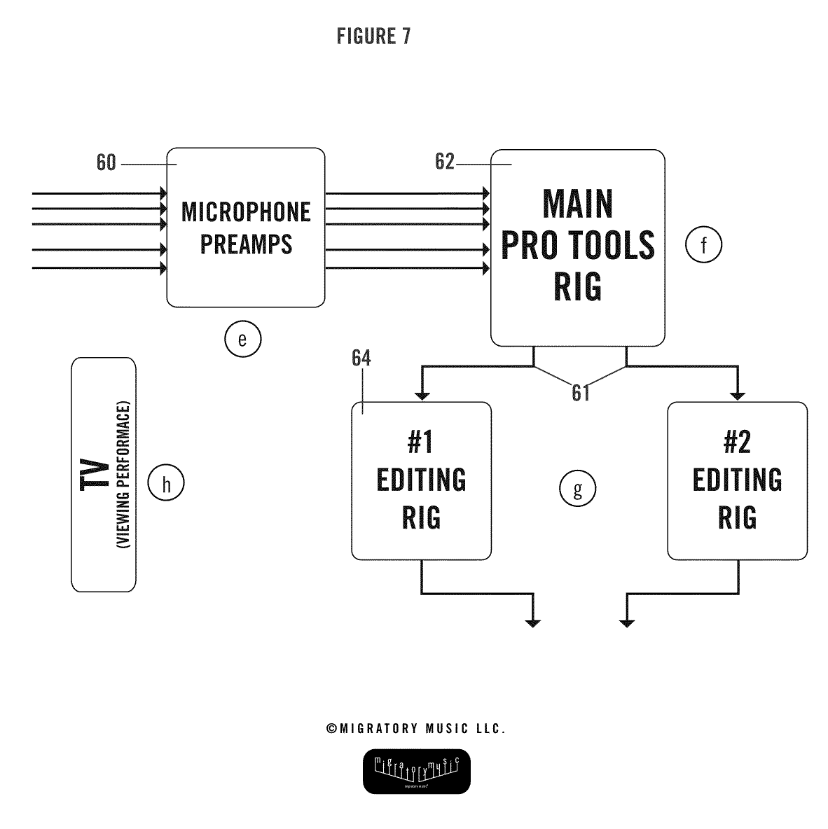

FIG. 7 describes the flow of the signal of the live music performance while within the isolated Ovation recording room (52 of FIG. 6). From the microphone preamps 60, the signal runs directly into an LCD3 ProTools Rig 62 that includes at least 2 Digidesign192 converters with at least 32 total channels of input, a MacPro computer with at least 5 gigs of RAM, and ProTools 8 software or higher. The signals are mixed inside the ProTools rig to the engineers taste according to the sound template and the mixed 2-track is output digitally in parallel 61 into 2 independent ProTools rigs 64, 66. Additionally, the Isolated Ovation Recording Room can also feature a video feed of the live music performance to a TV monitor 68 in the Isolated Ovation Recording Room so the engineers can have a visual of the performance on stage. In a preferred embodiment, editing Rigs #1 64 and #2 66 will not need as many inputs as the main ProTools rig because they are only receiving the mixed 2-track from the main ProTools rig and are not mixing the signals of the performance. The individually edited and finished tracks are then transferred 70 into a designated drop box folder on the Ovation master hub console where it can be accessed by the hardwired slave units and readied by the Ovation MP3-intergrated playlist software for consumer download.

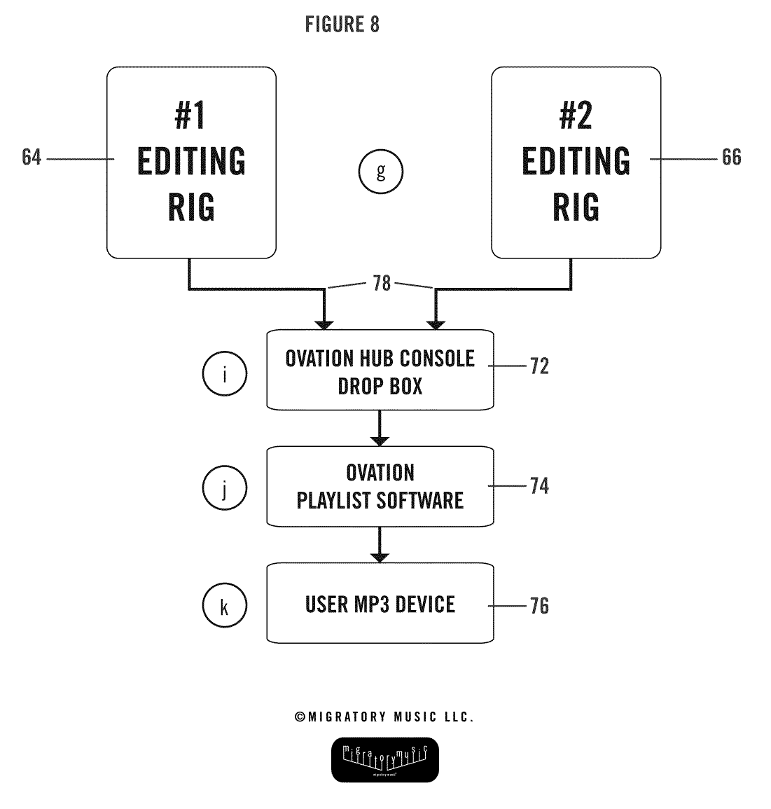

FIG. 8 illustrates a preferred embodiment of the editing rigs 64, 66 alternating recording and editing tracks of the live music performance to minimize the amount of time required to record and edit the performance in order to allow a concert attendee to purchase a digital recording of the live music performance before leaving the concert venue. In a preferred embodiment, the Ovation recording engineers ready the finished track for consumer download within a minute of the performance conclusion. For optimum Ovation performance and sound quality, the engineer must rely on the ability to get microphone levels and record audio during the artist's sound check prior to the show. This is of the utmost importance because of the nature of this digital product being instantaneously delivered. The engineer will be able to set levels for the stage microphones running from the 3-way splitter and the 2 extra room condenser microphones using the microphone preamps during sound check. Once levels are set, the engineer will put the main ProTools rig into record and record as much of the sound check as possible. After sound check, the engineer can then use this recorded audio to get a template mix together using plugins as desired. Once the ProTools mix is set where the engineer is satisfied with the sound quality, it will be used as a thru mixer for the live show to 2 track; meaning that the main ProTools rig will not actually be doing the recording itself. All the tracks will be set to input so that the signals simply pass through the rig with the levels and processing having previously been set by the engineer. It will sum inside the rig and exit as a 2-track signal. This signal will be output digitally and simultaneously from 2 outputs so the signal can travel into the 2 independent editing rigs 64, 66.

In a preferred embodiment, the recording and production process of Editing Rig #1 and Editing Rig #2 makes the recording instantaneously deliverable. Editing Rigs #1 and #2 will work as a team, switching off each song and uploading the finished track to the drop box folder on the Ovation master hub console. When the actual performance begins, the mix will be controlled by the engineer on the main ProTools rig, which is set on input, with levels and signal processing as needed, going into the 2 editing rigs simultaneously recording the 2 track as previously stated. Innovating the live recording process, when the first song ends and the second song begins, Editor #1 takes his rig out of record and trims the beginning and end of the track to a set standard, name the region with the order number and name (ex. “1. Song Title”) and then takes the finished and edited region and exports it as a file to the drop box folder on the Ovation hub master hub console (See FIG. 8, 72). The “naming the region” step is crucial because as the files are deposited into the drop box, the list will be able to stay in order if the tracks are numbered correctly. This will eliminate another step of having someone assemble the tracks in order. Once Editor #1 has done this they put their Editing Rig #1 back into record. Once the second song has finished, Editor #2 takes his Editing Rig #2 out of record and does the same process, trimming the ends, naming, and exporting the region as a file to the final destination. The process of trimming the region and exporting the track should not take more than 45 seconds. It is imperative that the uploading of each track happens as fast as possible for the simple reason that consumers will exit the venue within minutes of the performance conclusion.

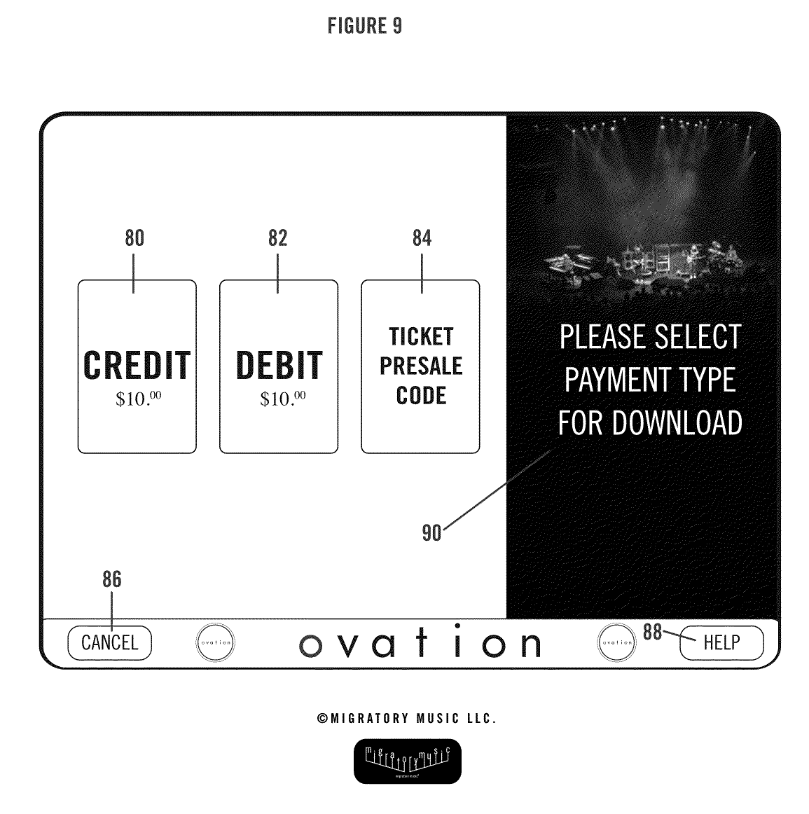

FIG. 9 illustrates a preferred embodiment of the screen that a consumer will encounter upon approaching the interactive system. At this initial screen shot, the consumer has the option of selecting a payment method for purchasing a live music performance digital recording. In the depicted embodiment, the options are for payment by credit 80, debit 82, or ticket presale code 84. The consumer also has the option of canceling the process through the cancel button 86 or entering the system's help function through pressing the help selection 88.

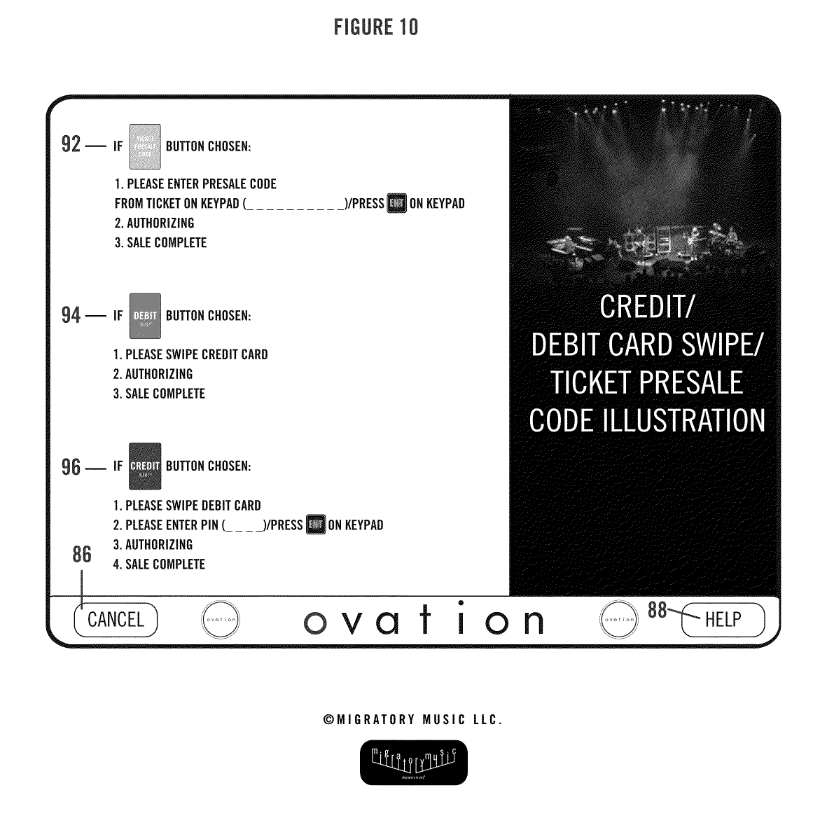

FIG. 10 is a screen shot illustrating the processes the system undertakes after a consumer selects one of the options found in FIG. 9. If the ticket presale code button is chosen, the screen prompts the consumer to enter a presale code 92. Subsequently the system authorizes the code and completes the sale. If the credit button is chosen 94, the system prompts the consumer to swipe a credit card. Subsequently, the system authorizes the transaction and completes the sale. If the debit button is chosen 96 the system prompts the consumer to swipe his or her debit card then enter a pin using the keypad. The system subsequently authorizes the transaction and completes the sale.

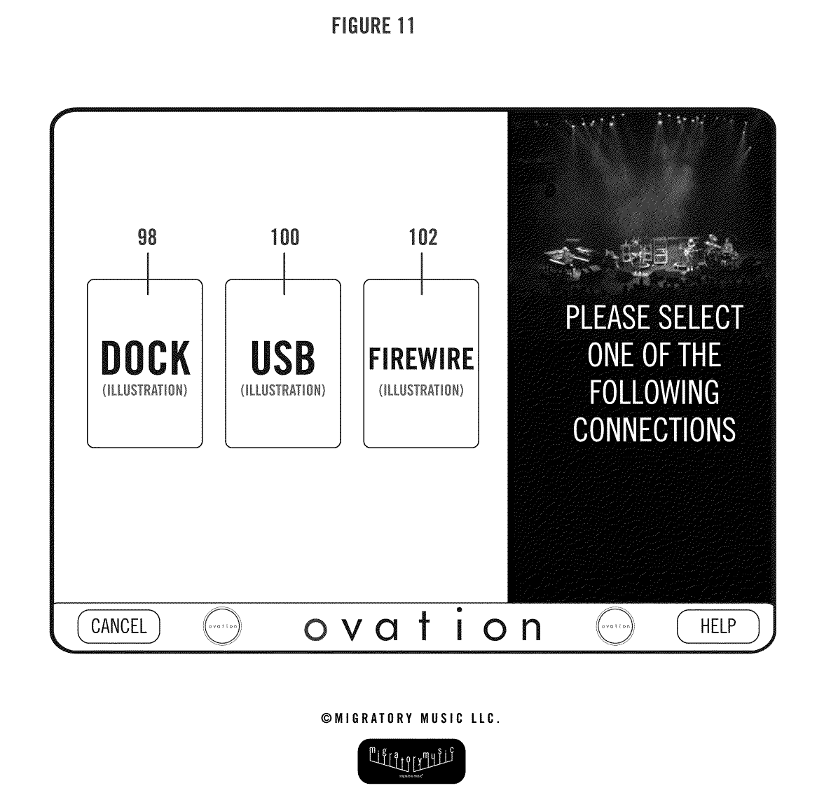

FIG. 11 illustrates the consumer's options for selecting an interface system through which to download the live music performance digital recording to the consumer's device. In a preferred embodiment, the system has a selection for a dock 98 for an iPod, a USB selection 100 and a fire wire selection 102.

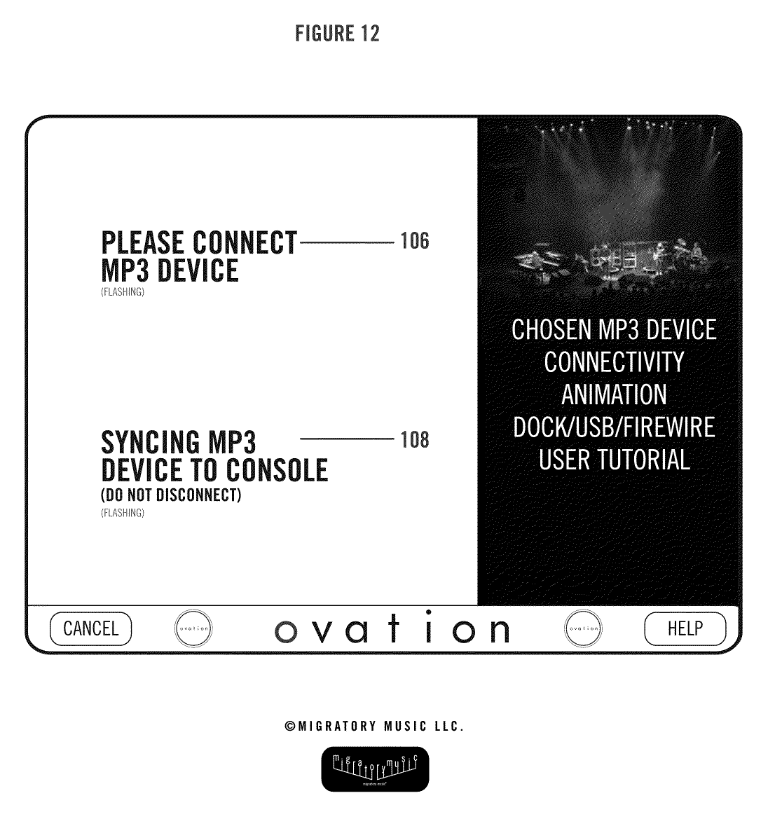

FIG. 12 illustrates a screen shot of the preferred embodiment of the system directing a consumer to act after making a selection as found in FIG. 11. The screen will prompt a consumer to connect the MP3 player 106 and subsequently will inform the consumer when the system is syncing the MP3 device to the console 108. The system will also inform the consumer not to disconnect the MP3 device from the console while the device is synching with the console or downloading the consumer's purchase.

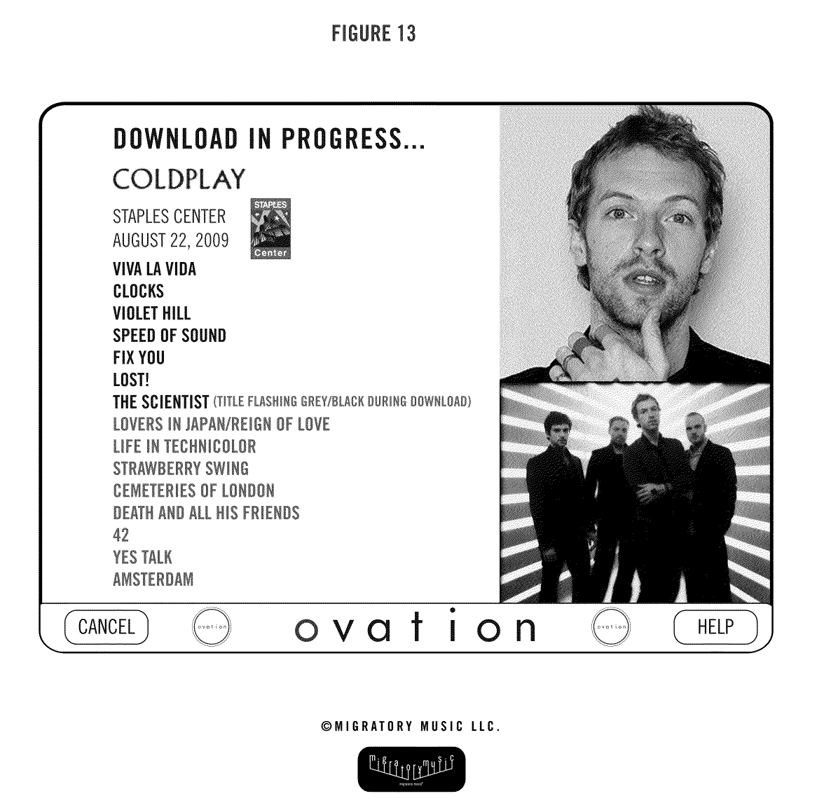

FIG. 13 illustrates a screen shot of the system after the system has synced with the consumer's MP3 player. As illustrated, the system shows that the download is in progress. The screen provides the consumer with an indication of the progression of the download of the live music performance digital recording.

FIG. 14 illustrates the screen shot of the system after the consumer has completed the transaction and download of live music performance digital recording. This screen shot informs the consumer that the download is complete and the consumer can disconnect his or her MP3 player.

In conclusion, while there is shown and described the present preferred embodiment of the invention, it is to be distinctly understood that this invention is not limited thereto but may be variously embodied to practice within the scope of the following claims. From the foregoing description, it will be apparent that various changes may be made without departing from the spirit and scope of the invention as defined by the following claims.

1. A live performance digital recording, distribution, and digital advertising system for recording and distributing a live performance digital recording, said system comprising:
a live performance digital recording system configured for digitally recording and editing a live performance;
a plurality of towers configured for distributing said live performance digital recording, wherein said towers comprise at least one computer system configured for accepting payment from a consumer, at least one interactive touch screen configured such that a user can select a live performance digital recording to purchase and download to a digital player, and a display screen configured for displaying digital streaming images and video;
wherein said towers are configured such that when said towers are aligned said display screens of said towers are configured to form a synchronous streaming billboard screen for displaying digital images and video; and
wherein said live performance digital recording system is configured to record said live performance digital recording from said live performance and configured to transmit said live performance digital recording to a location configured such that said live performance digital recording is instantaneously available for download by a consumer through said consumer purchasing a digital copy of said live performance digital recording through said tower.

2. The live performance digital recording, distribution, and digital advertising system of claim 1, wherein said live performance digital recording system comprises:
at least one microphone configured for transmitting a signal of said live performance;
at least one mixing board configured to mix said signal, wherein said mixing board is configured to mix said signal according to a template mix, wherein said template mix comprises a preset template mix set before the commencement of said live performance, wherein said system is configured to split said signal into at least two signals either during or subsequent to mixing;
at least two editing stations, wherein said live digital recording system is configured to transmit mixed signals to at least one of said editing stations, wherein a first editing station is configured to begin recording a first mixed signal at least at the start of said live misc performance, wherein said first editing station is configured to stop recording said signal at an end of a first track, wherein a second editing station is configured to begin recording a second mixed signal at least at a second track at the start of said live performance or at least at the start of a second track, wherein said first editing station is configured to edit said first track while said second editing station is recording said second track, wherein said second editing station is configured to stop recording said signal at an end of said second track, wherein said second editing station is configured to edit said second track while said first station is recording a third track; and
wherein said first editing station and said second editing station are configured to alternate recording and editing tasks until said live performance is complete, wherein said system is configured such that when said first station or said second station are done editing each of said tracks said system is configured to transfer said tracks to a location configured such that said tracks are available for download by a consumer through said tower.

3. The live performance digital recording, distribution, and digital advertising system of claim 1, wherein said plurality of towers comprises ten towers, wherein at least two of said towers are configured such to be aligned such that the combined display screens of each tower create said synchronous streaming display.

4. The live performance digital recording, distribution, and digital advertising system of claim 1, wherein said display screens of said towers comprise a majority of the height of said towers.

5. The live performance digital recording, distribution, and digital advertising system of claim 2, wherein said process of editing and transferring said tracks to said location wherein said tracks are available for download by a consumer through said tower is configured to occur in forty-five seconds or less such that consumers leaving a live performance venue are able to purchase said live performance digital recording promptly following an end of said live performance.

6. The live performance digital recording, distribution, and digital advertising system of claim 1, wherein said images displayed on said synchronous billboard fashion comprise still advertisements and video advertisements.

7. The live performance digital recording, distribution, and digital advertising system of claim 1, wherein said live performance digital recording further comprises a digital video recording of said live performance.

8. The live performance digital recording, distribution, and digital advertising system of claim 1, wherein said live performance digital recordings downloaded by a consumer are in MP3 format.

9. The live performance digital recording, distribution, and digital advertising system of claim 1, wherein at least one of said towers comprises a rubber resting pad for a digital recording player.

10. The live performance digital recording, distribution, and digital advertising system of claim 1, wherein said live performance video recordings comprise a sporting event.

11. A system for recording and distributing live performance digital recordings onto a digital recording device and for providing digital advertisements, said system comprising:
a live performance digital recording system configured for digitally recording a live performance, wherein said live performance digital recording system comprises at least one microphone configured for transmitting a signal of said live performance, at least one mixing board configured to mix said signal, wherein said mixing board is configured to mix said signal according to a template mix, wherein said template mix comprises a preset mix level set before the commencement of said live performance, wherein said live performance digital recording system is configured to split said signal into at least two signals either during or subsequent to mixing, wherein said live performance digital recording system comprises at least two editing stations, wherein said live performance digital recording system is configured to transmit said mixed signals to at least one of said editing stations, wherein a first editing station is configured to begin recording a first mixed signal prior to or at the start of a first track, wherein said first editing station is configured to stop recording said first mixed signal at the end of said first track, wherein a second editing station is configured to begin recording from at least one of said mixed signals prior to or at the beginning of a second track, wherein said first editing station is configured to edit said first track while said second editing station is recording said first track, wherein said second editing station is configured to stop recording said second mixed signal at the end of said second track, wherein said second editing station is configured to edit said second track while said first station is recording a third track, wherein said first editing station and said second editing station are configured to alternate recording and editing tasks until said live performance is complete, wherein when said first editing station or said second editing station are done editing said tracks said live performance digital recording system transfers said tracks to a location configured such that said tracks are available for download by a consumer;
a plurality of towers configured for distributing said live performance digital recording, wherein each of said towers comprise at least one system configured for accepting payment from a consumer, at least one interactive touch screen configured such that a user can select a live performance digital recording selection to purchase and download, at least one connection configured for a digital recording player to connect to, at least one interface configured for said user to download said live performance digital recording onto said playing device through said digital recording player connection from said location wherein said tracks of said live performance are available for download by a consumer, and wherein at least two of said towers comprise at least one display screen configured for streaming a digital advertising image or video; and
wherein said towers are configured to be interconnected such that said display screens of at least two of said towers portray a synchronous image, wherein said system is configured such that a consumer can download said live performance digital recording from at least one of said towers.

12. The live performance digital recording and distribution system of claim 11, wherein said system is configured such that said live performance digital recording is sent to at least one of said towers comprising a master hub tower, wherein said master hub tower transmits said live performance digital recording to at least one slave tower in said system, wherein said towers are configured such that a consumer can purchase and download live performance digital recordings from said towers.

13. The live performance digital recording and distribution system of claim 11, wherein said plurality of towers comprises ten towers.

14. The live performance digital recording and distribution system of claim 11, wherein said screens of said towers comprise screens of greater height than a remainder of said towers.

15. The live performance digital recording and distribution system of claim 11, wherein said process of editing said tracks and transferring said tracks to a location wherein said tracks are available for download by a consumer through said tower is configured to occur in forty-five seconds or less such that consumers leaving a live performance venue are able to purchase said live performance digital recording immediately following a conclusion of said live performance.

16. The live performance digital recording and distribution system of claim 11, wherein said images and video displayed on said continuous billboard comprise advertisements.

17. The live performance digital recording and distribution system of claim 11, wherein said live performance digital recording comprises a video recording of said live performance.

18. The live performance digital recording and distribution system of claim 11, wherein at least one of said towers comprises a rubber resting pad configured for resting a digital recording player.

19. A method of recording and distributing a live performance digital recording, wherein said method comprises:
providing a live performance digital recording system;
providing a live performance digital distribution system, wherein said live performance digital distribution system comprises a plurality of towers, wherein said towers comprise at least one system configured for accepting payment from a consumer, at least one interactive touch screen configured such that a user can select a live performance digital recording selection to purchase and download at least one live performance recording player connection, wherein said live performance recording player connection comprises a digital recording download system configured for said user to download a digital live performance digital recording onto a live performance recording player, at least one system configured for a live performance recording player to interface with said live performance digital distribution system, wherein each of said towers comprises an display screen configured for displaying advertisements or similar material;
digitally recording a live performance, wherein digitally recording said live performance comprises the steps of:
a. generating a template mix prior to the commencement of said live performance;
b. mixing a signal of said live performance generated by a microphone concurrently while the live performance is occurring;
c. recording said live performance signal by using at least two recording and editing stations, wherein a first track of said live performance is recorded by a first recording and editing station, wherein at the end of said first track said first recording and editing station stops recording said live performance signal, a second recording and editing station records a second track, wherein while said second recording and editing station is recording said second track said first recording and editing station edits said first track and transfers said first track to a location wherein said first track is available for purchase and download, wherein when said second recording and editing station stops recording said second track said first recording and editing station begins recording a third track of said live performance, wherein when said second recording and editing station stops recording said second live track said second recording and editing station edits said second track and transfers said second track to a location wherein said second track is available for purchase and download; and
d. repeating said steps a-c until said live performance is complete;
dispensing said live performance digital recording, wherein said live performance digital recording tracks are dispensed by performing the following steps:
e. attaching a live performance recording player device to at least one of said towers via said interface;
f. selecting a live performance digital recording for purchase;
g. purchasing said live performance digital recording; and
h. downloading said live performance digital recording from at least one of said towers.
